(19) United States
(12) Patent Application Publication
(10) Pub. No.: US 2020/0028180 A1
(43) Pub. Date: Jan. 23, 2020

(54) ANODES, PREPARATION METHOD THEREOF, AND LITHIUM ION SECONDARY BATTERIES

(71) Applicant: Microvast Power Systems Co., Ltd., Huzhou City, Zhejiang Province (CN)

(72) Inventors: SUMIHITO ISHIDA, Huzhou City, Zhejiang Province (CN); SHENGCHEN YANG, Huzhou City, Zhejiang Province (CN); WENJUAN LIU MATTIS, Huzhou City, Zhejiang Province (CN); ZHUOQUN ZHENG, Huzhou City, Zhejiang Province (CN); XIANG LI, Huzhou City, Zhejiang Province (CN); YANG WU, Huzhou City, Zhejiang Province (CN)

(21) Appl. No.: 16/470,971

(22) PCT Filed: Dec. 18, 2016
(86) PCT No.: PCT/CN2016/110596

§ 371 Date: Jun. 18, 2019

(51) Int. Cl. H01M 4/66; H01M 4/62; H01M 10/0525

(52) U.S. Cl. CPC H01M 4/663; H01M 4/667; H01M 2004/027; H01M 10/0525; H01M 4/622

(57) ABSTRACT

The present disclosure provides an anode, which includes a current collector and a carbon fiber layer that is coated onto the current collector and includes oxygen-containing functional groups. The present disclosure also provides a method for preparing the anode, especially preparing the carbon fiber layer. In addition, the present disclosure provides a lithium ion secondary battery including the anode above.

### FIELD OF THE INVENTION

The present disclosure relates to anodes used in lithium secondary batteries, a method for preparing the same, and a lithium secondary battery including such anodes.

### BACKGROUND OF THE INVENTION

Compared with conventional lead-acid batteries or nickel-metal hydride (NiMH) batteries, lithium ion secondary batteries have higher energy density. Therefore, they have been widely used as power sources of portable electronic equipment such as mobile phones, digital cameras, and notebook computers. In recent years, energy savings and environment protection have seen increased emphasis. As a clean and environmental-friendly energy source, lithium ion batteries have found commercial applications in hybrid electric vehicles (HEV), blade electric vehicles (BEV), and energy storage for solar power generation and wind power generation industries, among other things. However, further technical development in such fields will require increased battery capacity and longer life-span.

Conventionally, lithium metal oxides, for example, lithium cobalt oxide (LiCoO₂), lithium manganate (LiMn₂O₄), lithium nickelate (LiNiO₂) or lithium iron phosphate (LiFePO₄), have been applied as cathode active materials of lithium ion secondary batteries.

With regard to the anode material, though Si and Sn alloys have been subject to significant research, such alloys have not been put into commercial use due to their disadvantages including expansion limitation, poor conductivity and low charge-discharge efficiency. Meanwhile, lithium metal or lithium-containing alloys have always been considered as anode active materials with high energy density. During charging, a reduction reaction takes place and lithium metal is produced; when discharging, lithium metal is oxidized to lithium ions.

However, such lithium metal or lithium-containing alloys also have their disadvantages when used in batteries. First, during charging, the produced lithium metal crystallizes to form small lithium particles or lithium dendrites on the anode. Such small lithium particles or lithium dendrites mainly accumulate on surfaces of anodes, which rapidly decreases the life-span of the batteries. Second, when accumulated to a certain extent, lithium dendrites will puncture the lithium battery separator, which leads to short circuiting of the batteries and safety risks. Third, such small lithium particles have high specific surface area and also have high activity, especially under high temperature, which will also lead to safety risk. Fourth, along with the process of oxidation-reduction reactions of lithium ions, lithium metal is precipitated on the anodes, which increases the thickness of the anodes. Fifth, the lithium metal that is precipitated on the anode surface is basically detached. Once the lithium metal becomes detached, it does not participate in charging or discharging process, which shortens the life-span of batteries. Sixth, if the electrodes are covered by a ceramic solid electrolyte, the solid electrolyte will expand/contract when charging/discharging due to the precipitation of lithium. Such expansion/contraction leads to cracks appearing in the solid electrolyte when there are external vibrations, which impedes the movement of lithium ions and disables the batteries. All the disadvantages above cause safety risk in batteries.

In order to make the oxidation-reduction reaction of the lithium metal reversible and solve these safety problems above, thin-film laminated batteries have been subject to significant research towards its actual application, wherein lithium metal is precipitated on current collectors. However, the preparation of such thin-film laminated batteries requires vacuum evaporation equipment, the use of which leads to poor production efficiency and high fabrication cost of batteries. Meanwhile, the thin-film laminated batteries also need more laminated layers, more separators as well as more current collectors, all of which inevitably decreases the energy density. Therefore, the thin-film laminated batteries could not solve the security problem.

In view of the above, it is desirable to provide anodes which can give the batteries higher capacity, higher energy density and longer life-span, and it is also desirable to provide batteries including such anodes.

### SUMMARY OF THE INVENTION

The present disclosure provides an anode including a current collector and a carbon fiber layer that is coated onto the current collector, with the carbon fibers comprising oxygen-containing functional groups on their surface. During charging, the surface of the carbon fiber is coated with lithium metal precipitation.

The present disclosure also provides a lithium ion secondary battery, which includes an anode, a cathode, a separator between the anode and the cathode, and an electrolyte immersing the anode and the cathode; the anode is as described above.

The present disclosure still provides a preparation method of the anode described above, which includes the following steps: providing iron metal particles; growing of carbon fiber head-product on surfaces of the iron metal particles; and treating of the carbon fiber head-product to yield a carbon fiber layer; wherein source gases for producing the carbon fiber head-product are a mixture of carbon-containing gas or aromatic solution and hydrogen.

The anode described above can give the batteries higher capacity, higher energy density and longer life-span. In such batteries, when lithium metal is precipitated in the anode, in the presence of the carbon fiber layer of the anode, expansion/contraction of the anode is reduced. Further, in the presence of the carbon fiber layer on the current collector of the anode, during charging, small lithium particles or lithium dendrites will not form on the anode surface, and detached lithium metal will not be produced. As a result, the battery capacity does not decrease. Therefore, the batteries of the present disclosure have higher capacity, higher energy density and longer life-span.

The anode of the present disclosure is a thick-film electrode produced by conventional coating equipment, instead of a thin-film electrode produced by CVD (chemical vapor deposition) or PVD (Physical vapor deposition).

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. These descriptions are not intended to be exhaustive nor to limit the invention to the precise forms disclosed.

The present disclosure provides an anode which includes a current collector and a carbon fiber layer, and the current collector is coated with the carbon fiber layer, wherein the said carbon fiber includes oxygen-containing functional groups on their surface. When charging, a reduction reaction will take place and lithium metal will be produced to cover surfaces of the carbon fiber.

In one embodiment, said oxygen-containing functional group on the carbon fiber is selected from at least one of the following: hydroxyl (—OH), carboxyl (—COOH), aldehyde (—CHO) and ether group (—COC—). Since such functional groups containing oxygen and hydrogen are coated on the surface of the carbon fiber, when lithium metal is precipitated on the surface of the carbon fiber, it is immobilized due to electrostatic attraction between lithium and the functional groups.

In contrast, in the case of graphite, carbon nano-tube or metal copper with less functional group on its surfaces, precipitated lithium metal is detached, it is difficult to immobilize the lithium metal on the surfaces of the graphite, carbon nano-tube or metal copper. Further, when the lithium metal is detached, it is difficult to maintain a conductive network in the electrodes, and that is the reason why the capacity of batteries decays. Practically, during charging, the detached lithium metal adheres onto the separator or floats in the electrolyte. The detached lithium metal is inclined to react with oxygen and be oxidized. The oxygen involved in the oxidation reaction is released from a cathode, or derived from the decomposition of the electrolyte. A violent oxidation reaction will lead to thermal runaway.

In the carbon fiber, the oxygen-carbon ratio should be controlled in a suitable range. In one embodiment, an oxygen-carbon ratio is between 0.001 and 0.05. If the oxygen-carbon ratio is less than 0.001, it is difficult for lithium metal to be immobilized on the surface of the carbon fiber; that is, this lithium metal is inclined to be detached. Accumulation of the detached lithium metal will further cause lithium dendrites. Meanwhile, if the oxygen-carbon ratio is higher than 0.05, lithium metal will be continuously oxidized, which will impede its discharge and diminish the average discharge capacity.

In another embodiment, the carbon fiber contains at least one of the following elements: boron (B), phosphorus (P), nitrogen (N) and sulfur (S). When such elements are contained in the carbon fiber structure, the crystallinity of carbon is improved, and its conductivity is also enhanced. In addition, these elements and oxygen have unpaired electrons. Electrostatic attraction between these elements (including oxygen, beryllium, phosphorus, nitrogen, sulfur) and lithium can restrict the production of detached lithium metal.

In another embodiment, the conductivity of the carbon fiber is above 10³S/cm. In such embodiment, the copper foil acts as current collector of the anode due to its high conductivity, and the carbon fiber layer is coated on the copper foil. If the conductivity of the carbon fiber is lower than 10³S/cm, then the surface of the copper foil tends to produce non-uniform lithium metal precipitation. Such precipitated lithium metal is inclined to be detached from the surface. As a result of the above, the conductivity of the carbon fiber is controlled to be above 10³S/cm.

In yet another embodiment, the carbon fiber layer on the current collector has a density between 0.05 g/cc and 0.5 g/cc. If the density is above 0.5 g/cc, there is not enough space for the lithium metal to precipitate and during precipitation the electrode itself will have to expand. The expansion of the electrode will increase the physical burden of the electrode, and decrease the life-span of the batteries. If the density is below 0.05 g/cc, though, the burden applied upon the electrode will be significantly reduced, the volumetric efficiency will be correspondingly reduced and lead to further capacity reduction.

The present disclosure also provides a rechargeable lithium ion secondary battery which includes the anode described above. To be more specific, the rechargeable lithium ion secondary battery includes an anode, a cathode, a separator between the anode and the cathode, and an electrolyte solution immersing the anode and the cathode.

Anode:

The anode includes a current collector and carbon fiber layer coated on the current collector, wherein the carbon fiber layer including carbon fiber and a binder. In one embodiment, the current collector of the anode is made of copper.

The binder has two functions, one is to make carbon fibers of the carbon fiber layer bond to each other, and the other is to make the carbon fiber layer readily bond to the current collector. In one embodiment, the binder is selected from a group including but not limited to the following: polyvinyl alcohol (PVA), carboxymethyl cellulose (CMC), hydroxypropyl cellulose (HPC), polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), Acrylate butadiene rubber, epoxy resin or nylon etc.

As mentioned above, the carbon fiber layer on the current collector has a density between 0.05 g/cc and 0.5 g/cc. In one embodiment, the density is measured by the following steps: first, cutting the electrode plates into rounds with a diameter of around 5 cm, and measuring the thickness and weight of the rounds individually; second, measuring the thickness and weight of the current collector in the electrode rounds individually; third, subtracting the weight of the current collector from that of the rounds to get a weight of the carbon fiber layer, and subtracting the thickness of the current collector from that of the rounds to get a thickness of the carbon fiber layer and further obtain a volume of the carbon fiber layer coated on the current collector; finally, the density of the carbon fiber layer is calculated from the volume and weight of the carbon fiber layer.

Optionally, in one embodiment, the carbon fiber layer also includes a conductive material. The conductive material functions to endow the anode with conductivity. Any conductive material which does not cause chemical change can be used as the conductive material of the invention. In one embodiment, the conductive material is selected from the following: carbonaceous materials such as natural graphite, artificial graphite, carbon black, acetylene black, conductive carbon black or carbon fiber etc.; metal powder or metal fiber such as copper, nickel, aluminum or silver; conductive polymer such as polyphenyl derivatives, or a mixture of the above.

Cathode:

The cathode of the rechargeable lithium metal battery includes a current collector and a cathode active material layer coated on the current collector. The cathode active material layer includes a cathode material, a binder and optional conductive material. In one embodiment, the current collector can be made of aluminum or other materials. In another embodiment, the cathode active material includes at least one of the following: lithium cobalt oxide (LiCoO₂, abbr. as LCO), lithium manganate (LiMn₂O₄, abbr. as LMO), lithium nickel cobalt manganate (LiNi_{1-x-y}CoₓMn_{y}O₂, abbr. as NCM), lithium nickel cobalt aluminum oxide (NCA), lithium iron phosphate (LFP), lithium manganese iron phosphate (LiMn_{0.6}Fe_{0.4}PO₄, abbr. as LMFP) and so on.

The binder of the cathode functions to make the particles of the cathode active material bond with each other and to make the cathode active material bond to the current collector. In one embodiment, the binder is selected from but not limited to the following: polyvinyl alcohol (PVA), carboxymethyl cellulose (CMC), hydroxypropyl cellulose (HPC), diacetyl cellulose, polyvinyl chloride (PVC), carboxylic polyvinyl chloride, polyvinyl fluoride (PVF), ethylene oxide polymer, polyvinylpyrrolidone (PVP), polyurethane (PU), polytetrafluoroethylene (PTFE), polyvinylidene fluoride (PVDF), polyethylene (PE), polypropylene (PP), styrene-butadiene rubber (SBR), Acrylate butadiene rubber, epoxy resin, or nylon etc.

The conductive material of the cathode functions to endow the cathode with conductivity. Any conductive material which does not cause chemical change can be used as the conductive material of the invention. In one embodiment, the conductive material is selected from the following: carbonaceous materials such as natural graphite, artificial graphite, carbon black, acetylene black, conductive carbon black or carbon fiber etc.; metal powder or metal fiber such as copper, nickel, aluminum or silver; conductive polymer such as polyphenyl derivatives, or a mixture of the above.

In view of the above, both the cathode and the anode can include the conductive material and the binder. The preparation method of the cathode is as below, which includes the following steps: first, mixing the cathode active material, the binder, and the conductive material (if necessary) with a solvent, and obtaining the cathode active material mixture; second, coating the cathode active material mixture onto the current collector of the cathode, then drying it to yield a cathode. The preparation method of the anode includes the following steps: first, mixing the carbon fiber, the binder, and the conductive material (if necessary), with a solvent, and obtaining the carbon fiber mixture; second, coating the carbon fiber mixture onto the current collector of the anode, and then drying it to yield an anode. In one embodiment, the solvent used can be N-methylpyrrolidone (NMP), but another solvent could be used.

Electrolyte:

The electrolyte of the battery includes a non-aqueous organic solvent and a lithium salt. The non-aqueous organic solvent functions as a medium to facilitate the movement of the ions participating in the electrochemical reaction. In one embodiment, the non-aqueous organic solvent is selected from the following: carbonate solvent, carbonate ester solvent, ester solvent, ether solvent, ketone solvent, alcohol solvent, and non-protonic solvent.

In one embodiment, the carbonate ester solvent is selected from but not limited to the following: dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), or butylenes carbonate (BC).

In another embodiment, the solvent is a mixture of chain carbonate compounds and cyclic carbonate compounds. The mixture above can improve the dielectric constant, and yield a low viscosity solvent. In still another embodiment, the volume ratio of the cyclic carbonate compounds to the chain carbonate compounds is 1:1 to 1:9.

In still another embodiment, the ester solvent is selected from but not limited to the following: methyl acetate, ethyl acetate, propyl acetate, vinyl acetate, methyl propionate, ethyl propionate, γ-butyrolactone, decanolactone, valerolactone, mevalonolactone or caprolactone.

In yet another embodiment, the ether solvent is selected from but not limited to the following: dibutyl ether, tetraethylene glycol dimethyl ether, diethylene glycol dimethyl ether, ethylene glycol dimethyl ether, 2-methyltetrahydrofuran, tetrahydrofuran. In still another embodiment, the ketone solvent is cyclohexanone etc., and the alcohol solvent is ethanol, isopropanol, or another alcohol solvent.

The non-aqueous organic solvent above can be used alone or as a combination of the above. When at least two solvents are mixed together and acting as the non-aqueous organic solvent, the volume ratio of the components in the mixture can be adjusted according to the properties of the batteries.

Optionally, the non-aqueous organic solvent also includes an additive which aims to improve the security of the batteries. In one embodiment, the additive can be at least one of the following: phosphazene, phenylcyclohexane (CHB) or biphenyl (BP).

The lithium salt of the electrolyte is dissolved in the non-aqueous organic solvent and functions as a lithium ion source in the lithium battery. It is a material which promotes the movement of lithium ions between the anode and the cathode, and makes it possible for the lithium secondary batteries to operate smoothly.

In one embodiment, the lithium salt is selected from the following: LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are both natural numbers), LiCl, LiI, LiB(C₂O₄)₂, or lithium bis(oxalate)borate (abbr. as LiBOB), or a combination of the above.

In another embodiment, the concentration of the lithium salt is between about 0.1M and about 2.0M. A lithium salt with such concentration above can endow the electrolyte with suitable conductivity and viscosity. Thus, the electrolyte possesses excellent properties and facilitates the lithium ions to move effectively in it.

Separator:

The separator is used to separate the anode and the cathode, and provide a channel for the lithium ion to go through. It can be any conventional separator used in the lithium battery field. Further, the materials, which have low resistance and can easily absorb the electrolytes, can be used as the separator. In one embodiment, the separator is selected from the following: glass fiber separator, polyester fiber separator, polyolefin separator, aramid separator or a combination of the above. The polyolefin separator above includes polyethylene (PE) separator, polypropylene (PP) separator, and polytetrafluoroethylene (PTFE, or Teflon) separator. In one embodiment, the separators of the batteries are normally made of a polyolefin such as polyethylene or polypropylene. In another embodiment, to ensure thermal resistance and mechanical strength, the separators are coated with ceramic component or polymers such as aramid fibers. In still another embodiment, the separator is in a form of nonwoven fabrics or woven fabrics. In yet another embodiment, the separator is in a monolayer or a multilayer structure.

In one embodiment, celluloses with high permeability are applied in the separator. In that case, the movement of the lithium ions is not limited even at low temperatures where the viscosity of the electrolyte increases. Therefore, the application of the high permeable celluloses can increase the life-span at low temperatures.

Several embodiments are described below for purpose of illustration and description only. However, the descriptions are not intended to be exhaustive nor is the invention limited to the precise forms disclosed. For simplicity, the descriptions omit details which may be familiar to one with knowledge of the subject matter.

In the present disclosure, carbon fiber layer is coated on the current collector and becomes a frame of the anode. Conventional carbon fibers such as VGCF can be used in the invention. In addition, carbon nanofiber (CNF) synthesized from organic gas or organic solvents can also be applied. Generally, carbon fibers with more functional groups on the surface are preferred. When VGCF is graphitized at a temperature of over 2000° C., it is not suitable because functional groups on the surface decrease, and the oxygen density is also reduced. Similarly, carbon fibers with surfaces with no functional groups such as single-walled carbon nanotubes are also not suitable.

In one embodiment, the carbon fiber can also be prepared by using the following steps:

First, production of iron metal particles. This includes the following steps: dissolving iron (III) nitrate nonahydrate into ion exchange water to get an aqueous solution; spray-coating the aqueous solution onto a quartz glass plate; drying the quartz glass plate in a constant-temperature bath to remove the water on it, and yielding ferric nitrate. Then, reducing the ferric nitrate under reducing gas atmosphere (such as hydrogen or a gas mixture including hydrogen) at heating condition to produce particles of iron metal. During the reduction, metal particles with a particle size between 1 nm and 1000 nm, preferably 10 nm to 100 nm, are produced by controlling the reductive conditions.

Next, growth of carbon fiber head-product on the surface of the iron metal produced above under heat conditions. In one embodiment, the source gases for producing the carbon fiber are a mixture of carbon-containing gas or aromatic solution and hydrogen. The carbon-containing gas is selected from methane, ethane, ethylene, butane or carbon monoxide. The mole ratio (or volume ratio) of carbon-containing gas to hydrogen is between 1:4 and 4:1. The aromatic solution is selected from benzene, toluene, pyridine, or phenol etc. In another embodiment, the source gases also include substances containing nitrogen or sulfur element, for example, pyridine, thioether, etc.

Finally, treatment of the carbon fiber head-product. The steps are as follows: when the growth of the carbon fiber head-product is finished, replacing the source gases with inert gas, and cooling the carbon fiber head-product to room temperature in the reaction vessel, and then calcining the carbon fiber head-product at a temperature of 200° C. to 1200° C. under inert gas atmosphere to yield the carbon fibers. After being treated above, the carbon fibers have the following advantages: lithium on its surface can readily precipitate, as described above, the carbon fibers include the elements of oxygen, boron, phosphorus, nitrogen or sulfur, and such elements have interactions with lithium. The interactions above can restrict the lithium to drift away from the surface of the carbon fiber. These advantages endow the anode of the batteries with higher capacity and longer life-span.

### Embodiment 1

Preparation of the anode, which includes the following steps:

First, production of iron metal particles. The steps are as follows: dissolving iron (III) nitrate nonahydrate into 100 mL ion exchange water to get an aqueous solution; spray-coating the aqueous solution onto a quartz glass plate, drying the coating in a constant-temperature bath at 60° C. to remove the water and yield ferric nitrate particles; and then, placing the ferric nitrate particles into a quartz tube furnace and raising temperature to 600° C. under a reducing gas mixture which includes argon and hydrogen with a volume ratio of 1:1, to yield iron metal particles.

Next, growth of carbon fiber head-product. The process is as follows: replacing the reducing gas mixture of argon and hydrogen with source gases of hydrogen and toluene, the volume ratio of hydrogen and toluene in the source gases is 1:4, and maintaining the temperature under 600° C. for 3 hours to grow the carbon fiber head-product, which has a diameter of about 150 nm and a length of 0.5 to 1.0 mm.

Then, treatment of the carbon fiber head-product. The steps are as follows: when the growth of the carbon fiber head-product is finished, replacing the source gases with helium and cooling the carbon fiber head-product to room temperature, and then, raising temperature to 1000° C. and calcining the carbon fiber head-product at 1000° C. under helium atmosphere for 1 hour to yield the carbon fibers.

The infrared spectrum analysis of the carbon fibers prepared above shows the existence of hydroxyl (—OH) and carboxyl (—COOH) on the surface of the carbon fibers. Elemental analysis of the carbon fibers also shows that the oxygen-carbon ratio is 0.01, and the conductivity of the carbon fiber is 10⁴ S/cm.

Finally, preparation of the anode. The steps are as follows: mixing 90 wt % of the carbon fibers produced above, 10 wt % of polyvinyl fluoride (PVDF, acting as binder) and N—-methyl-2-pyrrolidone (NMP, acting as solvent) to form an electrode slurry, coating the electrode slurry onto a copper foil to form a slurry coating, the thickness of the copper foil is 8 μm; then finally, after the slurry coating is dried, rolling the slurry coating to yield an anode with an electrode density of 0.2 g/cc.

Preparation of the cathode: The steps are as follows: mixing 90 wt % of commercially available NCM (cathode active material) LiNi_{0.5}Co_{0.2}Mn_{0.3}O₂, 5 wt % of polyvinylidene fluoride and 5 wt % of acetylene black, dispersing the mixture in N-methylpyrrolidone to form slurry, then, spray-coating the slurry onto an aluminum current collector, which has a thickness of 12 μm, and after drying at 100° C., rolling the coating to form the cathode. The prepared anode has an electrode density of 3.0 g/cc, and a thickness of 70 μm.

Preparation of the battery: The steps are as follows: placing the anode and the cathode prepared above on the opposite, sandwiching a separator between the two electrodes, and winding them to form a jelly roll, then inserting the jelly roll into a container and injecting an electrolyte into the container to form a lithium ion battery A(18650). The electrolyte above is prepared by dissolving LiPF₆ in a mixture of ethylene carbonate (EC) and methyl ethyl carbonate (MEC), wherein the concentration of LiPF₆ is 1.0M and the volume ratio of EC to MEC is 3:7. The separator is a porous membrane of polyethylene.

### Embodiment 2

Embodiment 2 is similar to embodiment 1, and the differences are that during the growth of carbon fiber head-product, the toluene in the source gases is replaced by a mixture of toluene and phenol (95:5); and that the oxygen-carbon ratio of the prepared carbon fiber is 0.023. Other steps are the same as in embodiment 1, and yield a lithium ion battery B.

### Embodiment 3

Embodiment 3 is similar to embodiment 1, and the differences are that during the growth of carbon fiber head-product, the toluene in the source gases is replaced by a mixture of toluene and pyridine (95:5); and that the prepared carbon fiber contains nitrogen. The other steps are the same as in embodiment 1, and yield a lithium ion battery C.

### Embodiment 4

Embodiment 4 is similar to embodiment 1, and the differences are the following: 1) during treatment of the carbon fiber head-product step, after cooling the carbon fiber head-product to room temperature, blending 0.5% boric acid into the carbon fiber head-product and then calcining the mixture at 1200° C.; and 2) during the growth of carbon fiber head-product, the toluene in the source gases is replaced by pyridine to prepare a carbon fiber containing nitrogen element. Other steps are the same as in embodiment 1, and yield a lithium ion battery D.

### Embodiment 5

Embodiment 5 is similar to embodiment 1, and the difference is that: Instead of preparing the carbon fiber by the method of embodiment 1, the carbon fiber is commercially provided by Showa Denko. Other steps are the same as that in embodiment 1, and yield a lithium ion battery E.

### Embodiment 6

Embodiment 6 is similar to embodiment 1, and the difference is that: after rolling, the coated anode has an electrode density of 0.4 g/cc. Other steps are the same as in embodiment 1, and yield a lithium ion battery F.

### Embodiment 7

Embodiment 7 is similar to embodiment 1, and the difference is that: during preparation of the battery, the separator is a porous membrane of aramid fiber. Other steps are the same as in embodiment 1, and yield a lithium ion battery G.

### Embodiment 8

Embodiment 8 is similar to embodiment 1, and the difference is that: during preparation of the battery, the electrolyte also includes 10% phosphazene (an additive agent) with a fire point of over 100° C. Other steps are the same as in embodiment 1, and yield a lithium ion battery H.

### Comparative Example 1

Comparative example 1 is similar to embodiment 1, and the difference is that: after calcining, the yielded carbon fibers are further graphitized at 2500° C. under helium atmosphere. Other steps are the same as in embodiment 1, and yield a lithium ion battery I.

### Comparative Example 2

Comparative example 2 is similar to embodiment 1, and the difference is that: after cooling the carbon fiber head-product to room temperature, the carbon fiber head-product is calcined at 300° C. under oxygen atmosphere for 6 hours. Other steps are the same as in embodiment 1, and yield a lithium ion battery J.

### Comparative Example 3

Comparative example 3 is similar to embodiment 1, and the difference is that: the carbon fibers prepared by the method illustrated in embodiment 1 are replaced by commercially available carbon nanotubes (CNT) whose conductivity is 10⁴ S/cm. Other steps are the same as in embodiment 1, and yield a lithium ion battery K.

### Comparative Example 4

Comparative example 4 is similar to embodiment 1, and the difference is that: the carbon fibers prepared by the method illustrated in embodiment 1 are replaced by carbon black (Super P) whose conductivity is 10² S/cm. Other steps are the same as in embodiment 1, and yield a lithium ion battery L.

### Comparative Example 5

Comparative example 5 is similar to embodiment 1, and the difference is that: after rolling, the coated anode has an electrode density of 0.6 g/cc. Other steps are the same as in embodiment 1, and yield a lithium ion battery M.

### Comparative Example 6

Comparative example 6 is similar to embodiment 1, and the difference is that: after rolling, the coated anode has an electrode density of 0.03 g/cc. Other steps are the same as in embodiment 1, and yield a lithium ion battery N.

Battery Characteristics Evaluation

Charging the lithium secondary batteries A-N prepared by Embodiments 1-8 and Comparative examples 1-6 at a constant current of 1.0 A, until their voltages reach 4.2V. Then, discharging the batteries at a constant current of 1.0 A until their voltages reach 2.5V. And then taking the discharge capacity here as an initial capacity. In addition, charging the batteries at a constant current of 1.0 A until the voltage reaches 4.2V, and discharging at a constant current of 1.0 A until the voltage reaches 2.5V. After repeating the charging and discharging above for 500 cycles, a discharging capacity after 500 cycles is obtained. A ratio of the initial capacity to the discharging capacity after 500 cycles is named as capacity retention, which is used to evaluate the life-span characteristic of batteries.

Further, after evaluating the life-span as described above, charging the batteries at a constant current of 0.5 A until its voltage reaches 4.2V. Finally, placing the batteries into a heat-resistant and anti-explosion constant-temperature bath, elevating the temperature with a rate of 5° C./min to measure the self-heating of the batteries, and further evaluating the thermal stability of them.

TABLE 1
battery characteristics

| | | Oxygen-carbon | Additive | Anode Electrode | Initial Capacity | Capacity Retention | Thermal Runaway |
|---|---|---|---|---|---|---|---|
| | Batteries | ratio | agent | density (g/cc) | (mAh) | (%/after 500 cycles) | Temperature (° C.) |
| Embodiment 1 | A | 0.01 | — | 0.2 | 2754 | 80 | 182 |
| Embodiment 2 | B | 0.023 | — | 0.2 | 2715 | 86 | 182 |
| Embodiment 3 | C | 0.01 | N | 0.2 | 2706 | 85 | 185 |
| Embodiment 4 | D | 0.015 | B | 0.2 | 2713 | 86 | 181 |
| Embodiment 5 | E | 0.008 | — | 0.2 | 2780 | 78 | 178 |
| Embodiment 6 | F | 0.01 | — | 0.4 | 2962 | 70 | 170 |
| Embodiment 7 | G | 0.01 | — | 0.2 | 2783 | 85 | 205 |
| Embodiment 8 | H | 0.01 | — | 0.2 | 2690 | 78 | 230 |
| Comparative | I | 0.0003 | — | 0.2 | 2580 | 26 | 152 |
| example 1 | | | | | | | |
| Comparative | J | 0.08 | — | 0.2 | 2360 | 35 | 155 |
| example 2 | | | | | | | |
| Comparative | K | 0.0002 | — | 0.2 | 2567 | 42 | 142 |
| example 3 | | | | | | | |
| Comparative | L | 0.012 | — | 0.2 | 1860 | 28 | 158 |
| example 4 | | | | | | | |
| Comparative | M | 0.01 | — | 0.6 | 2243 | 26 | 158 |
| example 5 | | | | | | | |
| Comparative | N | 0.01 | — | 0.03 | 2543 | 88 | 181 |
| example 6 | | | | | | | |

Table 1 shows the characteristics of batteries A-N. As described above, carbon fibers in Embodiments 1-8 function as the frame of lithium precipitation, wherein the carbon fibers have oxygen contents in suitable range, and the anodes containing the carbon fibers also have electrode density in a suitable range. In contrast, other carbon-containing materials are applied in comparative examples 1-4, which are different to carbon fibers of the invention, and the electrode densities of comparative examples 5-6 deviate from the suitable range of the invention. The comparison shows that the batteries prepared by the method of the present disclosure have higher capacity, longer life-span and better thermal stability after 500 cycles than the comparative examples do.

The above shows that in batteries as described in the present disclosure, when lithium metal is precipitated in the anode, expansion/contraction of the anode is reduced by the carbon fiber of the anode, which benefits the batteries. Further, in the presence of the carbon fiber layer on the current collector of the anode, during charging, small lithium particles or lithium dendrites do not form on the anode surface, and detached lithium metal is not produced, and as a result, the battery capacity does not decrease. Because of the above, the batteries as described in the present disclosure have higher capacity, higher energy density and longer life-span.

It should be noted that the above particular embodiments are shown and described by way of illustration only. The above-described embodiments illustrate the scope of the disclosure but do not restrict the scope of the disclosure. The principles and the features of the present disclosure may be employed in various and numerous embodiments without departing from the scope of the disclosure.

1. An anode, comprising a current collector and a carbon fiber layer, the carbon fiber layer is coated onto the current collector, wherein the said carbon fiber comprises oxygen-containing functional groups.

2. The anode of claim 1, wherein said oxygen-containing functional group is selected from at least one of the following: hydroxyl, carboxyl and ether group.

3. The anode of claim 1, wherein an oxygen-carbon ratio of the carbon fiber is between 0.001 and 0.05; and/or a conductivity of the carbon fiber is above 10³S/cm.

4. The anode of claim 1, wherein the carbon fiber further comprising at least one element of the following: boron, phosphorus, nitrogen and sulfur.

5. (canceled)

6. The anode of claim 1, wherein the carbon fiber layer on the current collector has a density between 0.05 g/cc and 0.5 g/cc.

7. The anode of claim 1, wherein the carbon fiber layer comprising a binder, which is selected from the following: polyvinyl alcohol, carboxymethyl cellulose, hydroxypropyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, Acrylate butadiene rubber, epoxy resin or nylon.

8. The anode of claim 1, wherein the carbon fiber layer comprising a conductive material, which is selected from the following: natural graphite, artificial graphite, carbon black, acetylene black, conductive carbon black, carbon fiber, metal powder or metal fiber of copper, nickel, aluminum or silver; polyphenyl derivatives, or a mixture of the above.

9. A lithium ion secondary battery, comprising an anode, a cathode, a separator between the anode and the cathode, and an electrolyte, wherein the anode is described in claim 1.

10. The lithium ion secondary battery of claim 9, wherein the cathode comprising a current collector and a cathode active material layer coated on the current collector, which includes a cathode active material, a binder and optional conductive material.

11. The lithium ion secondary battery of claim 10, wherein the cathode active material comprising at least one of the following: lithium cobalt oxide, lithium manganate, lithium nickel cobalt manganate, lithium nickel cobalt aluminum oxide, lithium iron phosphate, and lithium manganese iron phosphate;
the binder is selected from the following: polyvinyl alcohol, carboxymethyl cellulose, hydroxypropyl cellulose, diacetyl cellulose, polyvinyl chloride, carboxylic polyvinyl chloride, polyvinyl fluoride, ethylene oxide polymer, polyvinylpyrrolidone, polyurethane, polytetrafluoroethylene, polyvinylidene fluoride, polyethylene, polypropylene, styrene-butadiene rubber, Acrylate butadiene rubber, epoxy resin, or nylon;
the conductive material is selected from the following: natural graphite, artificial graphite, carbon black, acetylene black, conductive carbon black or carbon fiber; metal powder or metal fiber of copper, nickel, aluminum or silver; polyphenyl derivatives, or a mixture thereof.

12. (canceled)

13. (canceled)

14. The lithium ion secondary battery of claim 9, wherein the electrolyte comprising a non-aqueous organic solvent and a lithium salt, the lithium salt is dissolved in the non-aqueous organic solvent optionally, the electrolyte further comprising 10% phosphazene with a fire point of over 100° C.

15. The lithium ion secondary battery of claim 14, wherein the non-aqueous organic solvent is selected from the following: carbonate solvent, carbonate ester solvent, ester solvent, ether solvent, ketone solvent, alcohol solvent, and non-protonic solvent, alone or in combination; optionally, the non-aqueous organic solvent further comprises an additive selected from phosphazene, phenylcyclohexane or biphenyl.

16. The lithium ion secondary battery of claim 15, wherein the carbonate ester solvent is selected from the following: dimethyl carbonate, diethyl carbonate, dipropyl carbonate, methylpropyl carbonate, ethylpropyl carbonate, methylethyl carbonate, ethylmethyl carbonate, ethylene carbonate, propylene carbonate, or butylenes carbonate;
the ester solvent is selected from the following: methyl acetate, ethyl acetate, propyl acetate, vinyl acetate, methyl propionate, ethyl propionate, γ-butyrolactone, decanolactone, valerolactone, mevalonolactone or caprolactone;
the ether solvent is selected from the following: dibutyl ether, tetraethylene glycol dimethyl ether, diethylene glycol dimethyl ether, ethylene glycol dimethyl ether, 2-methyl tetrahydrofuran, tetrahydrofuran;
the ketone solvent is cyclohexanone, and/or
the alcohol solvent is ethanol or isopropanol.

17. The lithium ion secondary battery of claim 15, wherein the non-aqueous organic solvent is a mixture of cyclic carbonate compounds and chain carbonate compounds with a volume ratio of 1:1 to 1:9.

18. (canceled)

19. (canceled)

20. (canceled)

21. (canceled)

22. The lithium ion secondary battery of claim 14, wherein the lithium salt is selected from the following: LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are both natural numbers), LiCl, LiI, LiB(C₂O₄)₂, or LiBOB, or the combination thereof a concentration of the lithium salt is 0.1M to 2.0M.

23. (canceled)

24. (canceled)

25. The lithium ion secondary battery of claim 9, wherein the separator is selected from the following: glass fiber separator, polyester fiber separator, teflon separator, polyethylene separator, polypropylene separator, polytetrafluoroethylene separator, aramid separator or a combination of the above; optionally, the separators are coated with ceramic component or aramid fibers.

26. (canceled)

27. A preparation method of the anode described in claim 1, comprising the following steps:
preparing iron metal particles;
growing of carbon fiber head-product on surfaces of the iron metal particles; and
treating of the carbon fiber head-product to yield a carbon fiber;
wherein source gases for producing the carbon fiber head-product are a mixture of carbon-containing gas and hydrogen, or aromatic solution and hydrogen; optionally, the source gases further comprising substances containing nitrogen or sulfur element.

28. The preparation method of claim 27, wherein the carbon-containing gas is selected from methane, ethane, ethylene, butane or carbon monoxide; and/or the aromatic solution is selected from benzene, toluene, pyridine, or phenol.

29. The preparation method of claim 27, wherein a volume ratio of carbon-containing gas to hydrogen is between 1:4 and 4:1.

30. (canceled)

31. The preparation method of claim 27, wherein after finishing the growth of the carbon fiber head-product, the carbon fiber head-product is treated as follows:
replacing the source gases with inert gas;
cooling the carbon fiber head-product to room temperature; and
calcining at a temperature of 200° C. to 1200° C. under inert gas atmosphere to yield the carbon fibers.
